(19) United States
(12) Patent Application Publication
(10) Pub. No.: US 2007/0041131 A1
(43) Pub. Date: Feb. 22, 2007

(54) Method for determining the position of a slider in an electromechanical valve

(76) Inventors: Dirk Kesselgruber, Montabaur (DE); Dogan Kamali, Wiehl (DE)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/505,623

(22) Filed: Aug. 17, 2006

(30) Foreign Application Priority Data
Aug. 17, 2005 (DE) 10 2005 038 934.1

(51) Int. Cl. G11B 5/54

(52) U.S. Cl. 360/256.2

(57) ABSTRACT

A method for determining the position of a slider in an electromechanical valve includes the steps of providing the slider with a coil and applying a voltage U to the coil. The current flowing through the coil is then measured and compared to a reference current value to determine the slider position.

### CROSS-REFERENCE TO RELATED APPLICATIONS

This application claims priority to German Patent Application No. 10 2005 038 934.1 filed Aug. 17, 2005, the disclosures of which are incorporated herein by reference.

### BACKGROUND OF THE INVENTION

The invention relates to a method for determining the position of a slider in an electromechanical valve.

In the automobile field, for example in active wheel suspension systems or electrohydraulic brake-regulating systems which are controlled by means of slider valves, the proper functioning of the slider valves is of great importance. The position of the slider at a particular moment can be detected by means of a sensor. A conclusion can then be drawn, from the actual position, as to whether the slider is functioning correctly or incorrectly (e.g. due to a jamming of the slider). However, determining the position of the slider by means of a sensor requires additional expenditure with regard to components and additional structural measures which lead to distinctly increased costs.

### BRIEF SUMMARY OF THE INVENTION

It is an object of the invention to provide a simple and favourably priced method for determining the position of a slider in an electromechanical valve.

According to the invention, the method for determining the position of a slider in an electromechanical valve comprises the following steps:

providing the slider with a coil,

applying a voltage to the coil,

measuring the flow of current through the coil, and

comparing the measured current flow with reference values.

The invention is based on the finding that the flow of current through the coil of the slider depends on the state of motion of the slider. When a voltage is applied to the coil, the flow of current is not constant as long as the slider is moving. The main reason for this is that a portion of the electrical energy which is supplied is used up by the movement of the slider. A conclusion can therefore be drawn regarding the position of the slider from the time-dependent rise in the flow of current by a comparison with the reference values. In particular, a jammed slider which is not moving can be quickly detected in this way.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a logic block diagram of the method according to the invention; and

FIG. 2 shows various time-dependent current flows in an electromechanical valve.

### DETAILED DESCRIPTION OF THE INVENTION

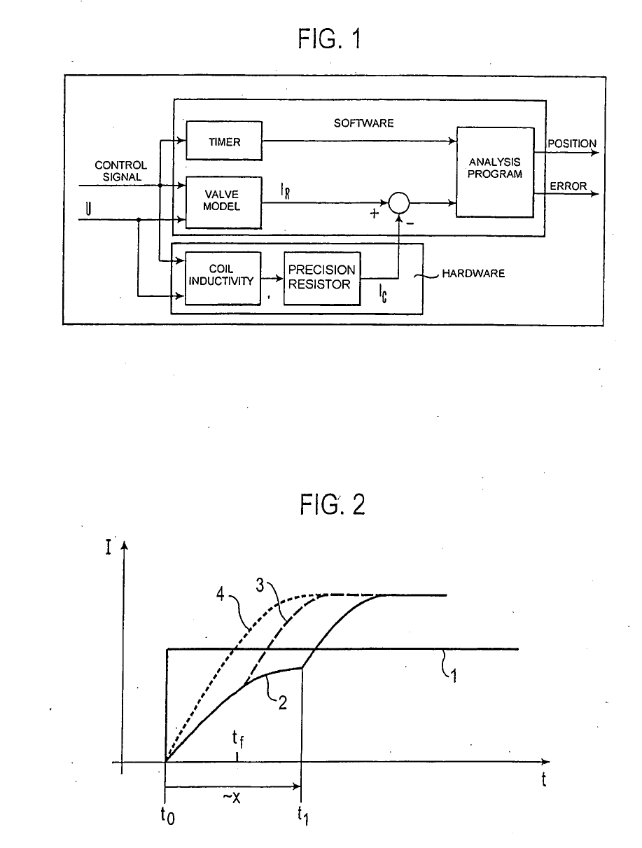

The process steps according to the invention for determining the position of a slider in an electromechanical valve can be seen from FIG. 1. A voltage U is applied to the slider, which is provided with a coil. The value of the voltage U is also supplied as an input quantity to a comparator program. The time-dependent current flow I_{C} through the coil is measured by means of a precision resistor. The start of measurement is established by switching on a control signal which simultaneously activates the movement of the slider.

The measured current flow I_{C} is automatically compared with reference values I_{R} of a valve model by means of a computer program. The reference values may either be based on a hypothetical sample valve or may be obtained by one or more reference measurements with real sample valves. The measured values I_{C} are subtracted from the reference values I_{R} (or vice versa). The reference values I_{R} are stored in a memory. It is established by means of an analysis program whether or not the deviations lie within a given tolerance band. The position of the slider or its incorrect functioning is then indicated depending on the result of the analysis.

A comparison of various time-dependent current flows is illustrated in FIG. 2. Curve 1 represents the control signal which is set at a point of time t₀. Curve 2 shows a reference path of a current flow I_{R} through a coil of a slider valve. A first phase with a path approximately proportional to the time t is followed at the point of time t₁ by an abrupt transition into a second phase with a steeper rise, which finally graduates into a saturation phase. The relatively flat rise in the first phase is explained by the movement of the slider from an initial position into a final position. The movement “dissipates” a particular proportion of the electrical energy which is supplied. This proportion ceases when the end position is reached at the point of time t₁.

Curve 3 represents a slider valve, the slider of which has become jammed during movement. This can be recognized in that the flow of current through the coil does not rise gently from a particular point of time t_{f} as in the reference path, but rather rises sharply because the slider, which is not continuing to move, has no kinetic energy anymore.

Finally, curve 4 shows the current path through the coil of a slider valve, the slider of which has not moved from the start.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method for determining the position of a slider in an electromechanical valve, the method comprising the following steps:
(a) providing the slider with a coil;
(b) applying a voltage to the coil;
(c) measuring the current flow through the coil; and
(d) comparing the measured current flow with reference current flow values to determine the slider position.

2. The method according to claim 1, wherein, during step (c), the measured current flow through the coil is measured vs. time over a particular period of time.

3. The method according to claim 2, wherein, during step (d), the measured current flow measured vs. time is compared with a time-dependent reference current flow formed from several reference current values.

4. The method according to claim 1, wherein the reference current values are determined by reference measurements.

5. The method according to claim 1, wherein the reference current values are stored in a memory.

6. The method according to claim 1, wherein the measured current flow is automatically compared with the reference current values by means of a computer program.
